(19) United States
(12) Patent Application Publication
(10) Pub. No.: US 2026/0094335 A1
(43) Pub. Date: Apr. 2, 2026

(54) Efficient Strategy Enlarging Receptive Field of Convolutional Neural Networks for MRI Reconstruction using Channel Shifting

(71) Applicants: Daniel B. Ennis, Palo Alto, CA (US); Chi Zhang, San Mateo, CA (US)

(72) Inventors: Daniel B. Ennis, Palo Alto, CA (US); Chi Zhang, San Mateo, CA (US)

(21) Appl. No.: 19/344,247

(22) Filed: Sep. 29, 2025

Related U.S. Application Data
(60) Provisional application No. 63/700,931, filed on Sep. 30, 2024.

(51) Int. Cl. G06T 11/00; G06T 5/60; G06T 5/70

(52) U.S. Cl. CPC G06T 12/30; G06T 5/60; G06T 5/70; G06T 2207/10088; G06T 2207/20084; G06T 2211/441

(57) ABSTRACT

A method of magnetic resonance imaging (MRI) comprises performing by an MRI scanner an accelerated MRI acquisition to produce an undersampled image containing undersampling artifacts; generating by the MRI scanner augmented inputs from the undersampled image using circular shiftings; assembling by the MRI scanner the augmented inputs to form concatenated image channels; mapping by the MRI scanner using a CNN the concatenated image channels to produce images with reduced undersampling artifacts; storing and displaying the images with reduced undersampling artifacts for medical diagnostic purposes.

### CROSS-REFERENCE TO RELATED APPLICATIONS

This application claims priority from U.S. Provisional Patent Application 63/700,931 filed Sep. 30, 2024, which is incorporated herein by reference.

### STATEMENT OF FEDERALLY SPONSORED RESEARCH

None.

### FIELD OF THE INVENTION

The present invention relates generally to medical imaging. More specifically, it relates to image reconstruction techniques for magnetic resonance imaging.

### BACKGROUND OF THE INVENTION

Accelerated MRI is widely applied in clinical settings to shorten the scan time by sub-sampling the underlying image in frequency domain (k-space), followed by reconstruction that removes aliasing artifacts from the acquired image. Recent studies have shown deep learning (DL)-based approaches using a convolutional neural network (CNN) can perform image reconstruction with significantly improved image quality compared to conventional reconstruction methods.

The limited receptive field of CNN is a major bottleneck to further improve image quality in most inverse imaging problems, such as image de-blurring, de-convolution, and image reconstruction. Specifically in accelerated MRI, sub-sampling in k-space is equivalent to convolving the underlying image with a point-spread function (PSF) equivalent to the inverse Fourier transform of the sampling pattern. This implies that any pixel in the acquired MRI image is a weighted sum of all pixels within the field of view (FOV). DL-based reconstruction with large receptive field (RF) is naturally demanded to recover the aliased pixels. Although many existing works have demonstrated the improvement brought by enlarged receptive field, the existing methods relied on either large convolution kernels or are based on multi-layer perceptron (MLP), which suffer from practicality issue: For the former, it costs considerable GPU memory and pro-long training/inference time. For the later, it can only handle with images in a fixed size.

### SUMMARY OF THE INVENTION

Herein is disclosed a method for MRI using a CNN design featured by large/global receptive field using small convolutions, which costs minor increments on GPU memory and execution time, while it is capable of handling arbitrary image size as a conventional CNN.

Compared to existing methods that use large convolution kernels and/or deformable convolutions, the present channel-shift CNN design costs significantly lower GPU memory, can be executed much faster, and it leads to no robustness issue during network training.

Compared to existing methods that are MLP-based (e.g., Transformer network), the present channel-shift CNN design allows flexible input image sizes, which has significant advantages in medical imaging.

The present technique has applications to medical image reconstruction, including MRI and CT.

In one aspect, the invention provides a method of magnetic resonance imaging (MRI) comprising: performing by an MRI scanner an accelerated MRI acquisition to produce an undersampled image containing undersampling artifacts; generating by the MRI scanner augmented inputs from the undersampled image using circular shiftings; assembling by the MRI scanner the augmented inputs to form concatenated image channels; mapping by the MRI scanner using a CNN the concatenated image channels to produce images with reduced undersampling artifacts; storing and displaying the images with reduced undersampling artifacts for medical diagnostic purposes. Generating the augmented inputs from the undersampled image using the circular shiftings preferably comprises circular shifting the undersampled image along one or more sub-sampled direction to produce shifted replicas of the undersampled image. Generating the augmented inputs from the undersampled image using the circular shiftings preferably comprises applying circular shifting with different step sizes to the undersampled image to produce circular shifted replicas, and concatenating the shifted replicas with the undersampled image along the channel dimension. Mapping by the MRI scanner using the CNN preferably comprises mapping by the MRI scanner using a CNN composed of regular 3×3 convolutions with extended channel size.

### BRIEF DESCRIPTION OF THE DRAWINGS

FIG. 1 is a schematic diagram illustrating the relationship between k-space and image space data in a typical accelerated MRI scan.

FIG. 2A is a schematic diagram illustrating how a 3×3 kernel is applied via a circular shifting window over a portion of an image.

FIG. 2B is a schematic diagram illustrating an equivalent matrix multiplication formulation of the application of a kernel to an image as shown in FIG. 2A.

FIG. 3A is a schematic diagram illustrating a typical convolutional layer using a small shift-invariant 3×3 convolution kernel.

FIG. 3B is a schematic diagram illustrating a convolutional layer using a larger convolution kernel that achieves a larger receptive field than that shown in FIG. 3A.

FIG. 4 is a processing pipeline illustrating image processing using a channel-shift CNN technique.

FIG. 5A is a processing pipeline illustrating the application of a channel-shift CNN to MRI reconstruction.

FIG. 5B is a processing pipeline illustrating end-to-end MRI reconstruction using channel-shift CNN.

FIG. 5C is a processing pipeline illustrating an unrolled network using channel-shift CNN.

FIG. 6 is an image grid showing representative image reconstruction results at rate-10 and rate-12 for conventional CNN reconstruction and for channel-shift CNN reconstruction.

FIG. 7 is an image grid showing representative reconstruction results at rate-10 and rate-12 using unrolled network based on a conventional CNN and channel-shift CNN.

FIG. 8 is an image grid showing representative reconstruction results at rate-8 and rate-15 comparing conventional CNN and channel-shift CNN images.

### DETAILED DESCRIPTION OF THE INVENTION

Accelerated MRI shortens scan time by sub-sampling in the frequency domain (k-space), followed by a reconstruction process that removes aliasing artifacts from the reconstructed image. Deep learning (DL)-based reconstruction methods using convolutional neural networks (CNNs) can significantly improve image quality compared to conventional methods. The limited receptive field of a CNN, however, limits further improvements of image quality in most inverse imaging problems, such as image de-blurring, de-convolution, and image reconstruction. Specifically, in accelerated MRI, sub-sampling in k-space is equivalent to convolving the underlying image with a point-spread function (PSF) equivalent to the inverse Fourier transform of the k-space sampling pattern. This implies any pixel in the acquired MRI image is a weighted sum of all pixels within the FOV. DL-based reconstruction with a large receptive field can be used to recover the aliased pixels.

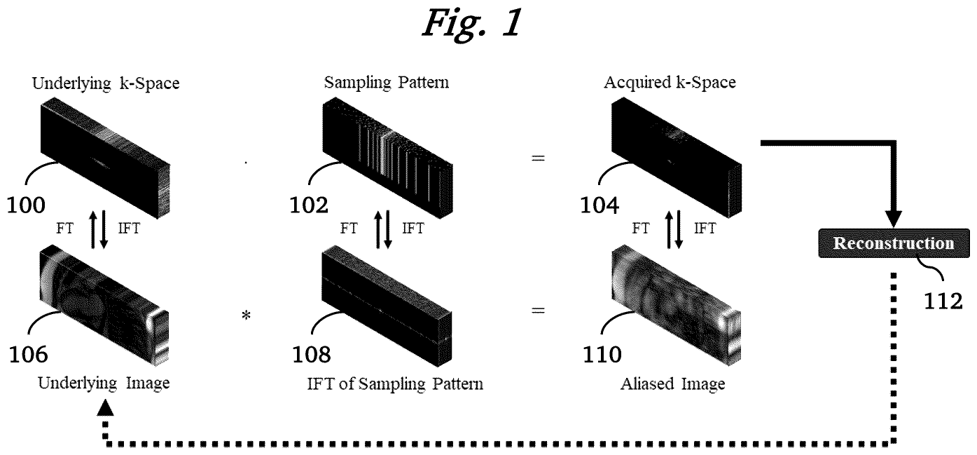

FIG. 1 illustrates a typical accelerated MRI scan which uses a sampling pattern 102 to acquire sub-sampled k-space measurements 104 of the underlying image in k-space 100, which leads to image-domain aliasing. In the image domain, such data acquisition of the aliased image 110 is equivalent to convolving the underlying image 106 with the inverse Fourier transform of sampling pattern 108. Reconstruction 112 aims to recover the underlying image 106 from the acquired aliased k-space image data 104, which can be considered as de-convolution problem where the convolution kernel spreads information across the entire field of view. This implies that an enlarged receptive field is beneficial whenever a CNN is involved in the reconstruction.

Although previous attempts have demonstrated that an enlarged receptive field can provide benefits, these previous methods rely on either large convolution kernels or are based on use of a multi-layer perceptron (MLP), which suffers from practical issues. Large convolution kernels incur a considerable GPU memory cost and prolonged training and inference times. MLPs have the drawback of only handling images of a fixed size.

We describe herein a CNN design characterized by an enlarged receptive field obtained with commonly used small convolutions. The approach incurs a minor incremental GPU memory usage and execution time, while it is capable of handling arbitrary image size.

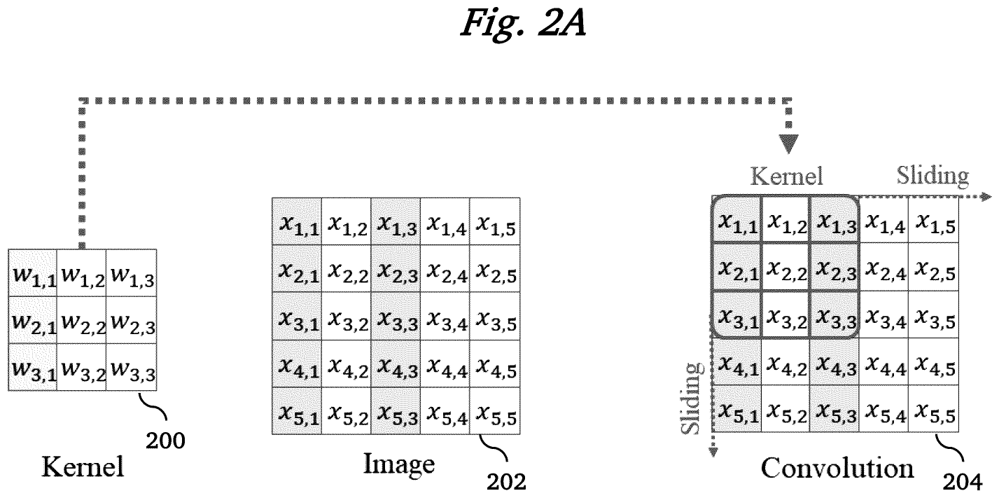

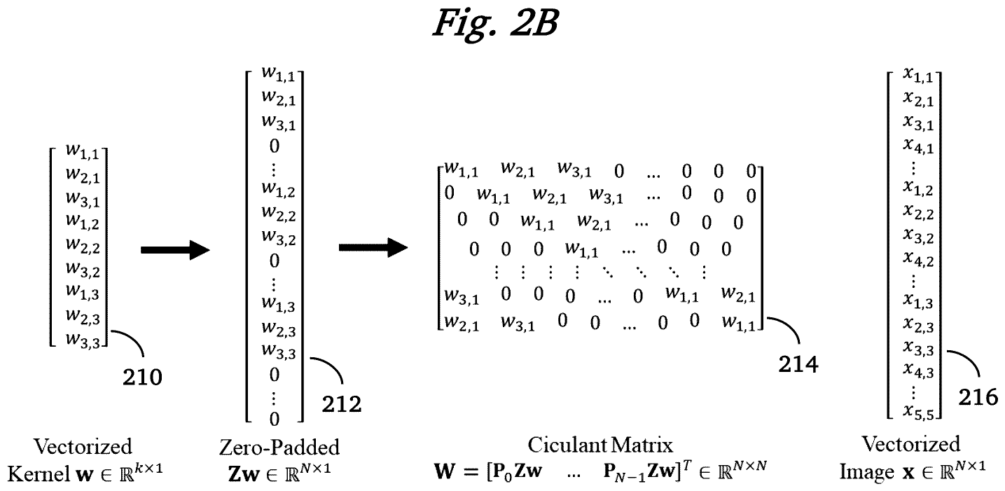

FIG. 2A and FIG. 2B illustrate an example of convolution and its equivalent matrix multiplication formulation, in an example of convolution using 3×3 kernel over 5×5 image. FIG. 2A shows a 3×3 kernel 200 applied via a circular shifting window over the image 202 to perform a convolution 204. In practice, the route of shifting the window is often fixed. The equivalent matrix multiplication formulation is shown in FIG. 2B. The kernel 210 and image 216 are both vectorized, where the kernel 210 has been zero-padded 212 to further build a circulant matrix 214. The circulant matrix consists of vectors permuted from the zero-padded kernel. As a result, the matrix-vector multiplication gives the same results as the convolution in FIG. 2A.

Without loss of generality, let x∈ [symbol] be a vectorized multi-dimensional image of N voxels. Assuming circular padding, convolution over x can be written as multiplication with a circulant matrix W∈ [symbol] :

$$y = Wx ∈ {ℝ}^{N} \qquad ( 1 )$$

W is characterized by the vectorized convolution kernel w∈ [symbol] of k weights, zero-padding operator Z∈ [symbol] , and a series of cyclic permutation operators Pₙ ∈ [symbol] :

$$W = {[ \begin{matrix}{P}_{0} Zw & {P}_{1} Zw & … & {P}_{N - 1} Zw\end{matrix} ]}^{T} \qquad ( 2 )$$

where Pₙ performs cyclic shift of the vector's entries by n units. Notice Z is determined by the original dimensionality of the convolution kernel and the input image before vectorization, Pₙ aligns weights from w to be convolved with the proper voxels according to the route of sliding convolution window.

Since W is circulant, it can be written as summation of circulant matrices Ŵₘ:

$$W = {\sum }_{m = 1}^{M} {\hat{W}}_{m} \qquad ( 3 )$$

which is characterized by vectors ŵₘ ∈ [symbol] :

$${\hat{W}}_{m} = {[ \begin{matrix}{P}_{0} Z {\hat{w}}_{m} & {P}_{1} Z {\hat{w}}_{m} & … & {P}_{N - 1} Z {\hat{w}}_{m}\end{matrix} ]}^{T} \qquad ( 4 )$$

where ŵₘ satisfies

$$w = {\sum }_{m = 1}^{M} {\hat{w}}_{m} \qquad ( 5 )$$

Further, let ŵₘ=Sₘŵₘ where Sₘ ∈ [symbol] is a masking operator that selects \hat{k}ₘ<k entries from w. At this point, a convolution using W can be expressed as

$$Wx = [ \begin{matrix}{\hat{W}}_{1} & {\hat{W}}_{2} & … & {\hat{W}}_{M}\end{matrix} ] [ \begin{matrix}x \\ x \\ ⋮ \\ x\end{matrix} ] \qquad ( 6 )$$

which suggests that a convolution using a relatively large kernel that consists of k weights can be expressed as multiple convolutions using small kernels. Notice ŵₘ is essentially a zero-padded subset of w, which is equivalent to smaller convolution kernels W̌ₘ ∈ [symbol] with its specific positional offsets Aₘ∈ [symbol] determined by Sₘ, such that ŵₘ=Aₘw̌ₘ. In practice, convolution is often computed along a fixed route. Such positional offsets are difficult to implement individually for each w̌ₘ, i.e., in practice, Aₘ=[I,0]^{T}=A for all m, where I∈ [symbol] denotes identity, 0∈ [symbol] is an all-zero matrix. Alternatively, one can permute the image to align w̆m:

$${\hat{W}}_{m} = {[ \begin{matrix}{P}_{0} ZA {\check{w}}_{m} & {P}_{1} ZA {\check{w}}_{m} & … & {P}_{N - 1} ZA {\check{w}}_{m}\end{matrix} ]}^{T} {B}_{m} \qquad ( 7 )$$

where Bₘ∈ [symbol] is a cyclic permutation operator. Combining (7) and (6) leads to a practically feasible formulation:

$$Wx = [ \begin{matrix}{{W}^{⌣}}_{1} & {{W}^{⌣}}_{2} & … & {{W}^{⌣}}_{M}\end{matrix} ] [ \begin{matrix}{B}_{1} x \\ {B}_{2} x \\ ⋮ \\ {B}_{M} x\end{matrix} ] \qquad ( 8 )$$

where W̌ₘ are circulant matrices characterized by Aw̌ₘ, corresponding to multiple convolutions following the same route of the sliding window. We refer to convolution in Eq. (8) as a “channel-shift” convolution, and the CNN built from such convolutions as a “channel-shift” CNN.

### Channel-Shift CNN

An image is often processed as multi-channel tensor, such as red, green, blue channels for nature images and real, imaginary channels in MRI. The receptive field describes the window size that covers pixels in the input data involved in generating a specific pixel in the output domain.

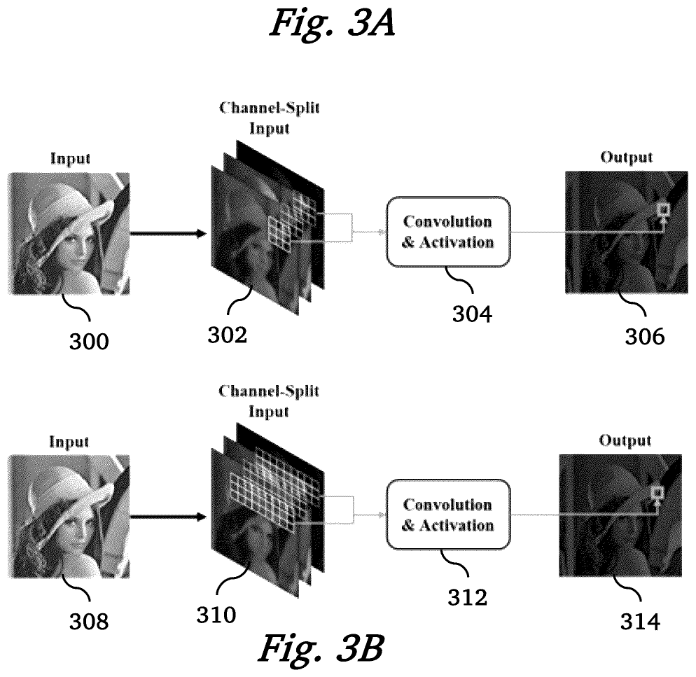

FIG. 3A and FIG. 3B illustrate the receptive field in a CNN. FIG. 3A shows a typical convolutional layer using a small shift-invariant 3×3 convolution kernel. An input image 300 is channel-split 302 and then processed through convolution and activation 304 to produce output 306. Each pixel in the output 306 is obtained from the convolution across all input channels, followed by an activation function. The receptive field describes how many pixels from the input were involved in the computation of a single pixel in the output. Although stacking small convolutions, as shown in FIG. 3A, can gradually increase the receptive field, an overly-deep CNN causes difficulties such as gradient vanishing during training. A more effective way to increase the receptive field is by using larger convolutions. FIG. 3B illustrates a convolutional layer using a large convolution kernel that achieves a larger receptive field. An input image 308 is channel-split 310 and then processed through convolution and activation 312 to produce output 314. However, this approach is difficult to optimize and it consumes a considerable amount of GPU memory and execution time.

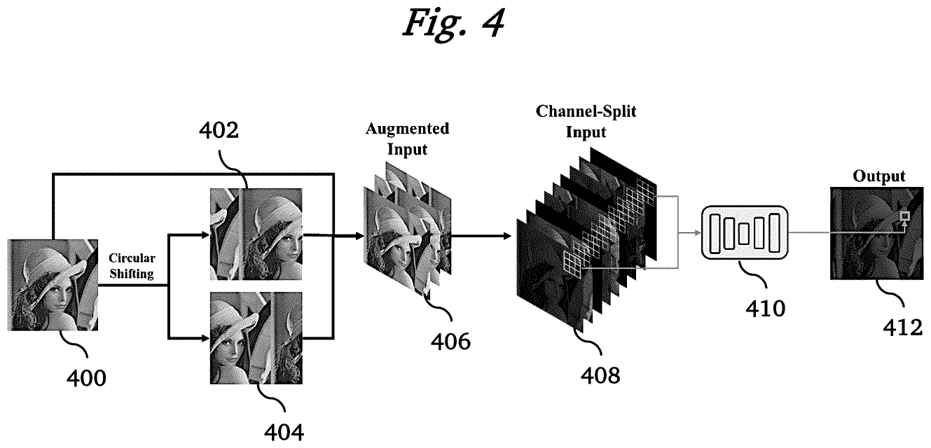

FIG. 4 illustrates a channel-shift CNN according to an embodiment of the invention. Instead of extensively stacking small convolutions or using large convolutions, a circular shifting with different step sizes is first applied to the input data 400 to produce circular shifted replicas 402, 404. The original data 400 is subsequently concatenated with its shifted replicas 402, 404 along the channel dimension to produce augmented input 406. In the case where the images contain multi-channel information (e.g., RGB channels), the image and its replicas in the augmented input are treated as multi-channel tensors, concatenated to produce an input tensor (i.e., channel-split input) 408. This input tensor 408 is subsequently fed to a CNN 410, which is composed of regular 3×3 convolutions with extended channel size, to produce output 412. Note the CNN 410 has an enlarged receptive field similar to using large convolution kernels in FIG. 3B. Convolutions using small kernels achieves a larger receptive field approximating the use of a large convolution kernels.

This technique allows enlarging the receptive field via channel-shifting. Circular shifting along the sub-sampled direction(s) is performed to produce shifted replicas of the input image. The replicas are subsequently concatenated with the input along channel dimension to produce an augmented input, which is fed into a regular CNN with additional channels in its input layer.

In some embodiments, the augmented input is fed into PCP-UNet with additional input channels. With a sufficient number of shifted replicas, this channel-shifting can enable having a global receptive field, while accepting arbitrary input sizes. Channel-shifting has a minor computational overhead equivalent to adding an additional convolutional layer with multiple channels. Channel-shifting has no additional memory consumption when the number of input channel is not greater than the maximum number of channels in the hidden layers.

### Implementation of Convolution in Practice

In modern machine learning frameworks, convolutions are implemented using either General Matrix Multiplication (GEMM)-based or transform-based methods. In the former, an input matrix is firstly built from vectorized image patches extracted by a sliding window. The vectorized convolution kernel is subsequently multiplied with the input matrix, followed by reshaping to produce the final output. In the latter, convolution is performed as point-wise multiplication in the Fourier domain, which requires additional FFT/IFFT over the image and kernel.

The present channel-shift convolution can accelerate the GEMM-based convolution that uses large kernels by splitting the large convolution into multiple smaller convolutions. For transform-based convolutions, the channel-shift convolution conceptually brings negative effect since the processing speed of transform-based convolution is independent of the kernel size.

Although transform-based method is known to be useful for accelerating convolutions, it is not ensured to outperform the GEMM-based method when implemented on a GPU in terms of processing speed and memory consumption. This is due to the fact that the GEMM-based method is more parallelizable, having a more hardware-efficient memory access pattern, and it generates fewer intermediate data.

Parallelizability tells how a single task can be split into several individual sub-tasks that can be processed in parallel. GEMM has high parallelizability, because each voxel in the output can be computed independently from other voxels. In the transform-based method, butterfly operations in the FFT and IFFT requires several sequential synchronized computations between threads, which becomes the bottleneck of its parallelizability.

In terms of GEMM-based convolution using large kernels, channel-shift convolution further parallelizes each large kernel convolution into smaller convolutions, which brings higher parallelizability.

The memory access pattern impacts the data I/O time while processing parallelized tasks. Optimized data access can significantly improve the processing speed, while it requires several restrictions to avoid: 1) multiple concurrent access to the same piece of memory, 2) access to memory larger than the hardware-determined cache and shared memory, and 3) memory access in a misaligned way.

It is easy to control memory access following the guidelines via the GEMM method using small kernels. For convolutions using larger kernels that exceed the capacity of the cache or shared memory, applying channel-shift convolution can reduce data size in each thread to meet the requirement. For transform-based method, it is often difficult to meet any of the above criteria, due to the FFT and IFFT steps.

Both GEMM and transform-based methods generate intermediate data during the process. Different from its formulation, GEMM is often optimized via recycling allocated memory rather than storing the entire input matrix. This allows less memory allocation and reduces the time allocating large pieces of memory. In the transform-based method, the kernel is firstly zero-padded to the size of the input data, and Fourier transform of both data and padded kernel needs to be stored and accessed. This becomes a major constraint of applying the transform-based method in practice, especially when handling large-sized data and/or large kernels.

### Application in MRI Reconstruction

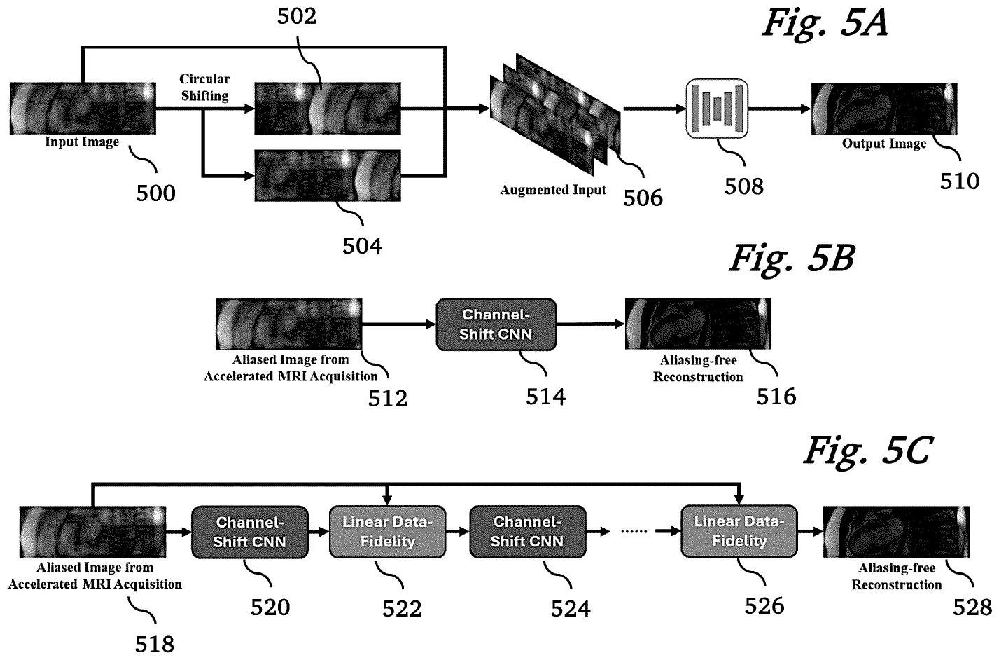

The present channel-shift CNN can be employed to perform end-to-end reconstruction of an accelerated MRI image, as well as regularization step in unrolled network. FIG. 5A is a flow chart of an MRI image 500 being processed by channel-shift CNN. An accelerated MRI acquisition is performed to generate MRI image 500 from a Fourier transform of raw undersampled k-space data. Circular shifting generates circular shifted images 502, 504, which are concatenated with the original image 500 to produce augmented input 506. Input 506 is concatenated from single-channel, complex-valued tensors, and then applied as input to CNN 508, which generates an output image 510. FIG. 5B shows end-to-end MRI reconstruction using the channel-shift CNN process of FIG. 5A. In end-to-end reconstruction, an accelerated MRI acquisition is performed to generate aliased MRI image 512 from a Fourier transform of raw undersampled k-space data. This aliased image 512 from the accelerated acquisition is input to the channel-shift CNN process 514, which maps it into aliasing-free image 516. FIG. 5C shows an unrolled network using channel-shift CNN. In unrolled network, channel-shift CNN steps 520, 524 can be inserted between (and just prior to) linear data-fidelity steps 522, 526 to produce reconstructed aliasing-free regularization image 528 from an aliased accelerated MRI acquisition image 518.

### Experiment Results

Experiments were performed using the fastMRI knee dataset and in vivo cardiac MRI cine dataset. In the knee data, we performed retrospective rate-10 and rate-12 undersampling. In the cardiac data, rate-8 and rate-15 retrospective undersampling were applied.

For reconstruction, we used a known unrolled network (e.g., a deep architecture based on a model-based deep learned priors framework, which unrolls an iterative algorithm into a deep network for solving inverse problems) with a CNN-based regularizer. We further use the present channel-shift convolution to replace the conventional convolution in the input layer of the CNN regularizer to build a channel-shift CNN.

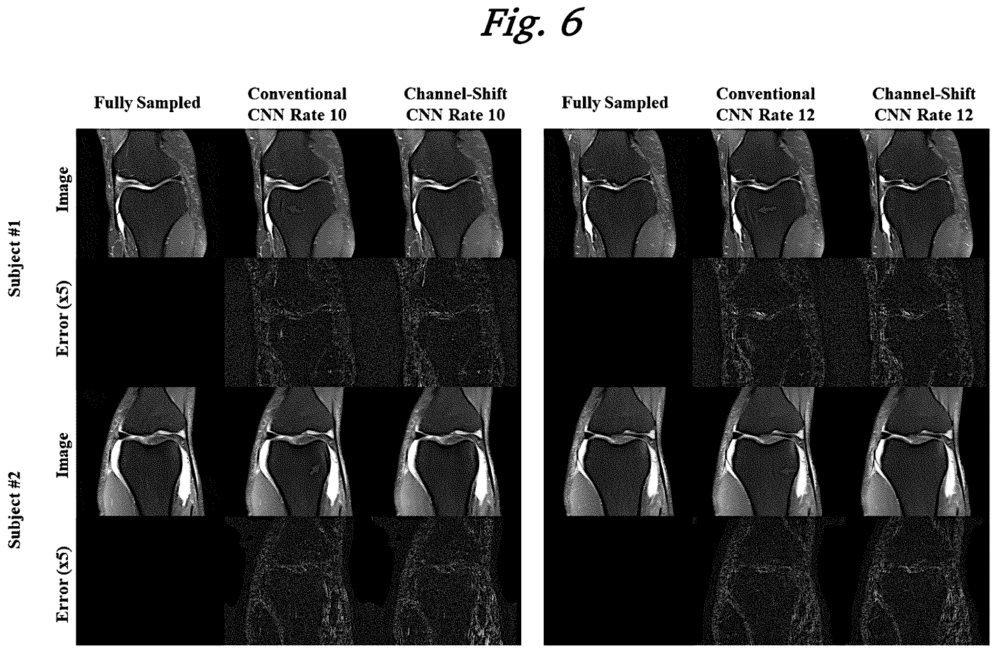

FIG. 6 is an image grid showing representative reconstruction results using unrolled network with a conventional CNN and our channel-shift CNN applied to the fastMRI knee dataset at rate-10 and rate-12. The four rows show images and corresponding error images for two subjects. The six columns show fully sampled, conventional CNN and channel-shift CNN images at rates 10 and 12. Due to the relatively high acceleration rates of 10 and 12, the conventional CNN reconstruction exhibits visible aliasing artifacts. In contrast, the channel-shift CNN shows no visible artifacts at both rates.

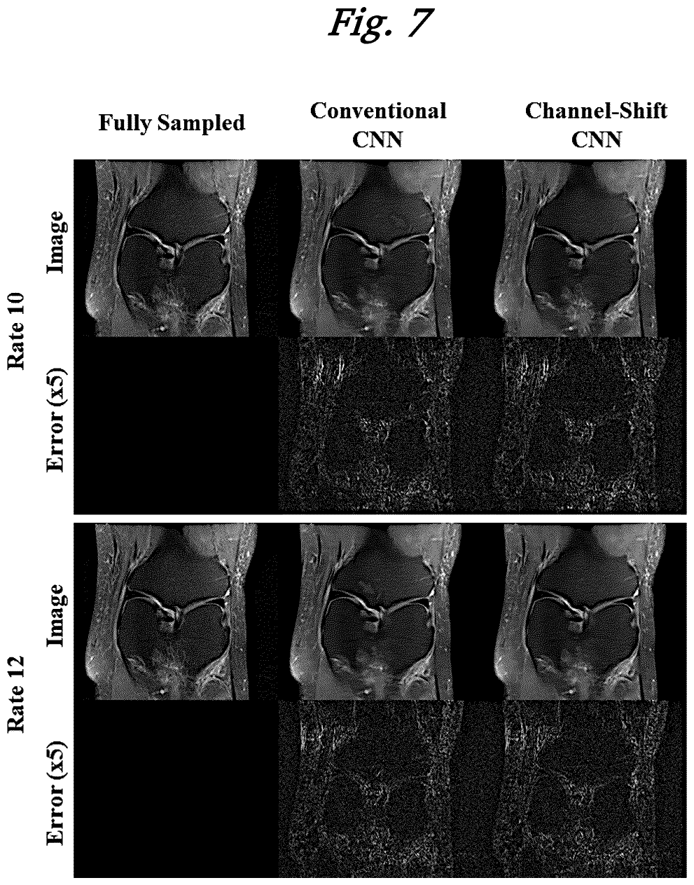

FIG. 7 is an image grid showing representative reconstruction results at rate-10 and rate-12 using unrolled network based on a conventional CNN and channel-shift CNN. The four rows show images and corresponding error images for rate-10 and rate-12. The three columns show fully sampled, conventional CNN and channel-shift CNN images. The unrolled network using a conventional CNN exhibits visible aliasing artifacts due to high acceleration rates, while the unrolled network based on our channel-shift CNN has successfully removed aliasing artifacts at both rates.

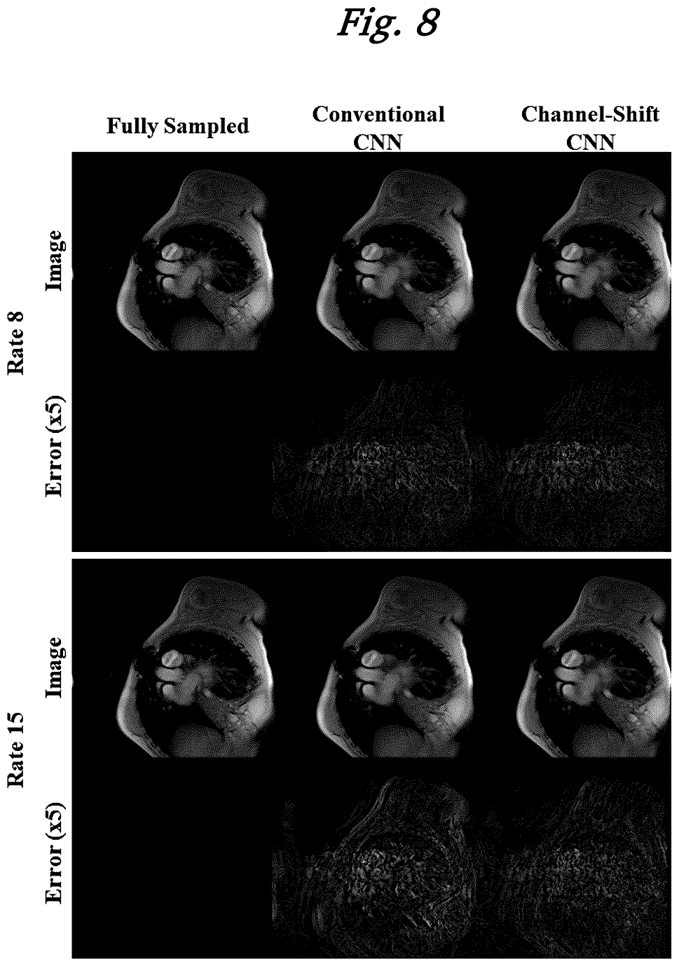

FIG. 8 is an image grid showing representative reconstruction results of rate-8 and rate-15 cardiac cine MRI. At rate-8, the channel-shift CNN shows a minor advantage compared to the conventional CNN. At higher the rate-15, the channel-shift CNN shows noticeable advantage in term of image quality compared to the conventional CNN.

1. A method of magnetic resonance imaging (MRI) comprising:
a) performing by an MRI scanner an accelerated MRI acquisition to produce an undersampled image containing undersampling artifacts;
b) generating by the MRI scanner augmented inputs from the undersampled image using circular shiftings;
c) assembling by the MRI scanner the augmented inputs to form concatenated image channels;
d) mapping by the MRI scanner using a convolutional neural network (CNN) the concatenated image channels to produce images with reduced undersampling artifacts;
e) storing and displaying the images with reduced undersampling artifacts for medical diagnostic purposes.

2. The method of claim 1 wherein generating the augmented inputs from the undersampled image using the circular shiftings comprises circular shifting the undersampled image along one or more sub-sampled direction to produce shifted replicas of the undersampled image.

3. The method of claim 1 wherein generating the augmented inputs from the undersampled image using the circular shiftings comprises applying circular shifting with different step sizes to the undersampled image to produce circular shifted replicas, and concatenating the shifted replicas with the undersampled image along the channel dimension.

4. The method of claim 1 wherein mapping by the MRI scanner using the CNN comprises mapping by the MRI scanner using regular 3×3 convolutions with extended channel size.
